(19) United States
(12) Patent Application Publication
(10) Pub. No.: US 2024/0187545 A1
(43) Pub. Date: Jun. 6, 2024

(54) VEHICLE CONTROL DEVICE, VEHICLE CONTROL METHOD, AND NON-TRANSITORY STORAGE MEDIUM

(71) Applicant: TOYOTA JIDOSHA KABUSHIKI KAISHA, Toyota-shi (JP)

(72) Inventors: Masashi NOSE, Nagoya-shi (JP); Tomoaki MIYAZAWA, Nagoya-shi (JP); Kazuya KUMAZAWA, Nagoya-shi (JP); Miki TSUJINO, Nagakute-shi (JP); Tsukasa KITAZAWA, Toyota-shi (JP)

(73) Assignee: TOYOTA JIDOSHA KABUSHIKI KAISHA, Toyota-shi (JP)

(21) Appl. No.: 18/500,335

(22) Filed: Nov. 2, 2023

(30) Foreign Application Priority Data
Dec. 5, 2022 (JP) 2022-194439

(51) Int. Cl. H04N 5/262; B60K 35/00; G08G 1/16

(52) U.S. Cl. CPC H04N 5/2628; B60K 35/00; G08G 1/167

(57) ABSTRACT

A vehicle control device including a processor. When a vehicle is executing driving assistance control to change lanes toward one side of either the left or the right, the processor generates a virtual viewpoint image representing an area positioned further in front of and at the other side than an occupant of the vehicle based on image data acquired by cameras mounted to the vehicle and based on a virtual viewpoint positioned further to another side of either the left or the right than a vehicle width direction center of the vehicle, and causes display of the virtual viewpoint image on a display device provided to the vehicle.

### CROSS-REFERENCE TO RELATED APPLICATION

This application is based on and claims priority under 35 USC 119 from Japanese Patent Application No. 2022-194439 filed on Dec. 5, 2022, the disclosure of which is incorporated by reference herein.

### BACKGROUND

### Technical Field

The present disclosure relates to a vehicle control device, a vehicle control method, and a non-transitory storage medium.

### Related Art

A vehicle described in International Publication (WO) No. 2019/038903 is provided with a display device that, when the vehicle is executing lane change assist control (LCA), is able to display a surroundings image that includes a highway image representing a highway the vehicle is traveling on and an other-vehicle image representing an other-vehicle positioned in surroundings of the vehicle. The surroundings image represents an imaging subject (for example, a highway and an other-vehicle) in an area positioned in front of the vehicle.

A virtual viewpoint when generating the surroundings image to be displayed on the display device of WO No. 2019/038903 is positioned at a vehicle width direction center in plan view. In other words, the image positioned at a vehicle width direction central portion of the surroundings image represents imaging subjects positioned in front of a vehicle width direction central portion of the vehicle. The image positioned at a vehicle width direction left edge portion of the surroundings image represents imaging subjects positioned further to the left side than a left edge portion of the vehicle. Furthermore, an image positioned at a vehicle width direction right edge portion of the surroundings image represents imaging subjects positioned further to the right side than a right edge portion of the vehicle.

This means that in the display device of WO No. 2019/038903 an area having a wide width positioned in front of the vehicle is displayed. There is accordingly room for improvement in the technology of WO No. 2019/038903 with respect to making an occupant of the vehicle who has looked at the display device during LCA execution correctly aware of a situation in an area positioned in a movement direction of the vehicle.

In consideration of the above circumstances, an object of the present disclosure is to obtain a vehicle control device, a vehicle control method, and a non-transitory storage medium capable of, during execution of driving assistance control performed to change lanes, making an occupant of a vehicle who has looked at a display device correctly aware of a situation in an area positioned in the movement direction of the vehicle.

### SUMMARY

A vehicle control device of a first aspect includes a processor. when a vehicle is executing driving assistance control to change lanes toward one side of either the left or the right, the processor generates a virtual viewpoint image representing an area positioned further in front of and further toward the one side than an occupant of the vehicle based on image data acquired by cameras mounted to the vehicle and based on a virtual viewpoint positioned further to the other side from out of toward the left or toward the right than a vehicle width direction center of the vehicle, and the processor displays the virtual viewpoint image on a display device provided to the vehicle.

The processor of the vehicle control device of the first aspect displays the virtual viewpoint image on the display device when the driving assistance control is being executed to change lanes of the vehicle toward the one side from out of toward the left or toward the right. The virtual viewpoint image is an image representing the area positioned further in front and further toward the one side than the occupant of the vehicle, and is generated based on the image data acquired by the cameras mounted to the vehicle and based on the virtual viewpoint positioned further to the other side from out of toward the left or toward the right than the vehicle width direction center of the vehicle. The vehicle control device of the first aspect is able, during execution of driving assistance control to perform a lane change, to make the occupant of the vehicle who has looked at the display device correctly aware of a situation in the area positioned in the movement direction of the vehicle.

A vehicle control device of a second aspect is the first aspect, wherein the display device is positioned further in front than a seat of the vehicle, the display device includes a display area capable of displaying the virtual viewpoint image, and the processor displays the virtual viewpoint image in an area on the one side of a left-right direction center of the display area.

The processor of the vehicle control device of the second aspect displays the virtual viewpoint image in the area further to the one side than the left-right direction center of the display area of the display device. Adopting such an approach means that the occupant of the vehicle who has looked at the display device readily directly ascertains that the virtual viewpoint image displayed on the display area represents an area in the progression direction of the vehicle (lane change direction). The vehicle control device of the second aspect is accordingly readily able to make the occupant of the vehicle who has looked at the display device correctly aware of a situation in the area positioned in the movement direction of the vehicle.

A vehicle control device of a third aspect is the first aspect or the second aspect, wherein the processor displays an image representing the vehicle on the display device.

The processor of the vehicle control device of the third aspect displays the image representing the vehicle on the display device. The vehicle control device of the third aspect accordingly readily makes an occupant who has looked at the display device aware of the positional relationships between the vehicle the occupant is riding in and any other-vehicles being displayed on the display device.

A vehicle control method according to a fourth aspect includes, when a vehicle is executing driving assistance control to change lanes toward one side of either the left or the right, by a processor, generating a virtual viewpoint image representing an area positioned further in front of and further toward the one side than an occupant of the vehicle based on image data acquired by a camera mounted to the vehicle and based on a virtual viewpoint positioned further to another side of either the left or the right of a vehicle width direction center of the vehicle, and causing display of the virtual viewpoint image on a display device provided to the vehicle.

A non-transitory storage medium of a fifth aspect is a non-transitory storage medium storing a program executable by a computer so as to perform processing. The processing includes, when a vehicle is executing driving assistance control to change lanes toward one side of either the left or the right generating a virtual viewpoint image representing an area positioned further in front of and further toward the one side than an occupant of the vehicle based on image data acquired by a camera mounted to the vehicle and based on a virtual viewpoint positioned further to another side of either the left or toward the right than a vehicle width direction center of the vehicle, and displaying the virtual viewpoint image on a display device provided to the vehicle.

As described above, the vehicle control device, the vehicle control method, and the non-transitory storage medium according to the present disclosure exhibit the excellent advantageous effect of being able, during execution of driving assistance control to perform a lane change, to make an occupant of a vehicle who has looked at a display device correctly aware of a situation in an area positioned in the movement direction of the vehicle.

### BRIEF DESCRIPTION OF THE DRAWINGS

Exemplary embodiments of the present disclosure will be described in detail based on the following figures, wherein:

FIG. 1 is a diagram illustrating an interior of a vehicle equipped with a vehicle control device according to an exemplary embodiment;

FIG. 2 is a plan view of the vehicle illustrated in FIG. 1;

FIG. 3 is a side view of the vehicle illustrated in FIG. 1;

FIG. 4 is a diagram illustrating a hardware configuration of the vehicle illustrated in FIG. 1;

FIG. 5 is a functional block diagram of the ECU illustrated in FIG. 4;

FIG. 6 is a plan view of the vehicle illustrated in FIG. 1, together with surrounding vehicles and highway;

FIG. 7 is a diagram illustrating a display device displaying an image expressing a surrounding vehicle and highway when LCA is not being executed;

FIG. 8 is a diagram illustrating a display device when LCA is being executed to change lanes toward the right side;

FIG. 9 is a diagram illustrating a display device when LCA is being executed to change lanes toward the left side; and

FIG. 10 is a flowchart illustrating processing executed by a CPU of an ECU.

### DETAILED DESCRIPTION

Description follows regarding an exemplary embodiment of a vehicle control device, a vehicle control method, and a non-transitory storage medium according to the present disclosure, with reference to the drawings. As appropriate in the drawings, an arrow FR indicates a vehicle front-rear direction front side, an arrow LH indicates a vehicle left-right direction left side, and an arrow UP indicates a vehicle height direction upper side.

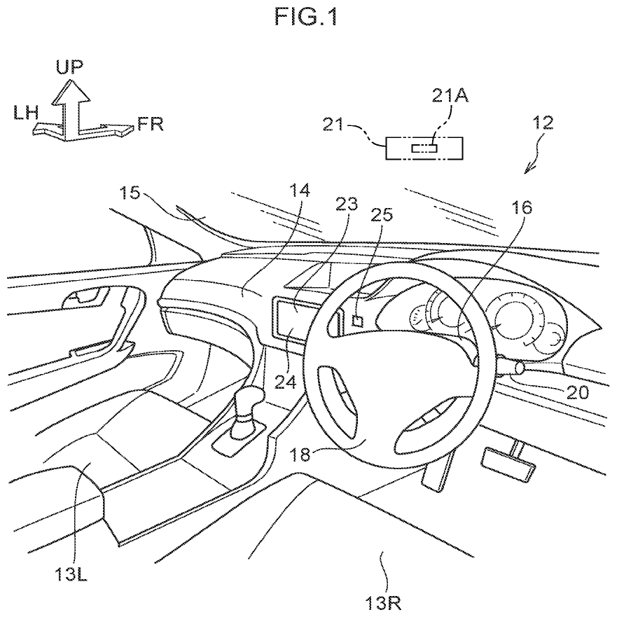

A vehicle 12 installed with a vehicle control device 10 includes an instrument panel 14 and a front windshield 15 such as illustrated in FIG. 1. A steering column 16 is provided to the instrument panel 14, and a steering wheel 18 is supported by the steering column 16 so as to be able to rotate. Moreover, a turn signal lever 20 is supported at a right side portion of the steering column 16 so as to be able to move.

The turn signal lever 20 is able to swing about a base portion (left end portion) thereof in both an upward (counterclockwise direction) and a downward (clockwise direction) with respect to the steering column 16. The position illustrated in FIG. 1 is an initial position of the turn signal lever 20. When a driver (occupant, omitted in the drawings) of the vehicle 12 imparts an external force to the turn signal lever 20, the turn signal lever 20 swings either to a left LCA operation position above the initial position, or to a right LCA operation position below the initial position (omitted in the drawings). Furthermore, when external force being imparted to the turn signal lever 20 positioned at either the left LCA operation position or the right LCA operation position is released, the turn signal lever 20 moves so as to return to the initial position automatically. The turn signal lever 20 is also able to swing between a left illumination position above the left LCA operation position and a right illumination position below the right LCA operation position.

As illustrated in FIG. 1, a sensor unit 21 is provided to an upper portion of a vehicle inside face of the front windshield 15. The sensor unit 21 includes a front center camera (camera) 21A that captures an imaging subject at a position in front of the front windshield 15 through the front windshield 15, a millimeter wave radar that transmits probe waves and receives reflected waves (omitted in the drawings), and a laser imaging detection and ranging (LIDAR) that scans in front of the vehicle 12 (omitted in the drawings).

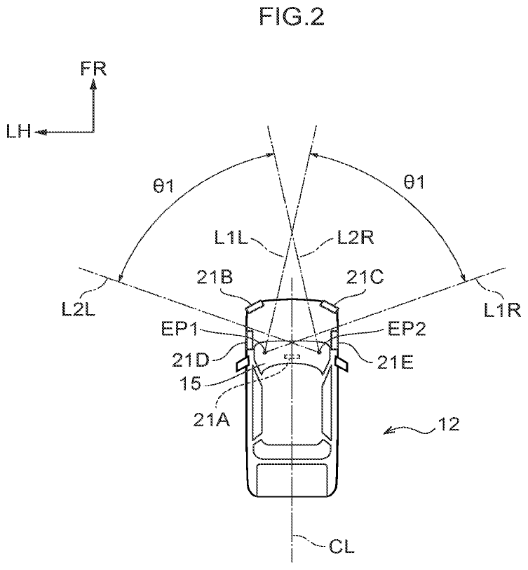

Moreover, as illustrated in FIG. 2, the vehicle 12 also includes a front-left camera (camera) 21B, a front-right camera (camera) 21C, a left side camera (camera) 21D, and a right side camera (camera) 21E. The front center camera 21A, the front-left camera 21B, and the front-right camera 21C capture imaging subjects at positions in an area further in front than their respective positions. The left camera 21D captures imaging subjects at positions in an area at the left side of the vehicle 12. The right camera 21E captures imaging subjects at positions in an area at the right side of the vehicle 12. The front center camera 21A, the front-left camera 21B, the front-right camera 21C, the left camera 21D, and the right camera 21E each have a specific angle of view.

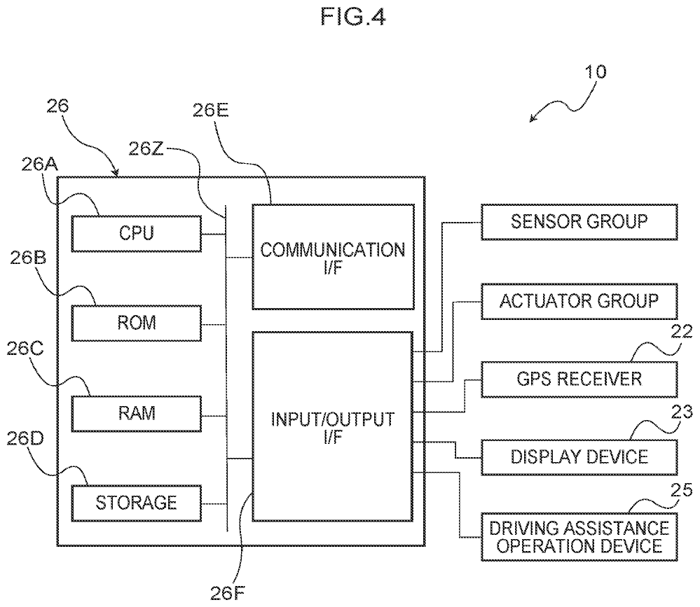

As illustrated in FIG. 4, the vehicle 12 includes a global positioning system (GPS) receiver 22. The GPS receiver 22 acquires information related to a position where the vehicle 12 is traveling by receiving GPS signals transmitted by GPS satellites (hereafter referred to as “location information”).

As illustrated in FIG. 1 and FIG. 4, a display device 23 is provided to the instrument panel 14. As illustrated in FIG. 1 and FIG. 7 to FIG. 9, the display device 23 includes a display area 24 slightly smaller than the external profile of the display device 23. The display device 23 is positioned further in front than left and right front seats (seats) 13L, 13R of the vehicle 12. In other words, the display device 23 is positioned further in front than the head (eyes) of occupants seated in the front seats 13L, 13R.

As illustrated in FIG. 1 and FIG. 4, a driving assistance operation device 25 is provided to the instrument panel 14. The driving assistance operation device 25 is a device to execute driving assistance control on the vehicle 12, as described later. The vehicle 12 is able to execute driving assistance control when the driving assistance operation device 25 is in an ON state. The vehicle 12 is not able to execute driving assistance control when the driving assistance operation device 25 is in an OFF state.

As illustrated in FIG. 4, the vehicle 12 includes an electronic control unit (ECU) 26 serving as a hardware configuration.

The ECU 26 is configured including a central processing unit (CPU) (processor) (computer) 26A, read only memory (ROM) (non-transitory storage medium) (recording medium) 26B, random access memory (RAM) 26C, storage (non-transitory storage medium) (recording medium) 26D, a communication I/F 26E, and an input/output I/F 26F. The CPU 26A, the ROM 26B, the RAM 26C, the storage 26D, the communication I/F 26E, and the input/output I/F 26F are connected together through an internal bus 26Z so as to be capable of communicating with each other.

The CPU 26A is a central processing unit that executes various programs and controls each section. The CPU 26A reads a program from the ROM 26B or the storage 26D, and executes the program using the RAM 26C as workspace. The CPU 26A performs control of each configuration and various computation processing according to programs stored on the ROM 26B or the storage 26D.

The ROM 26B stores various programs and various data. The RAM 26C serves a workspace to temporarily store programs and/or data. The storage 26D is configured by a storage device such as a hard disk drive (HDD), solid state drive (SSD), or the like, and stores various programs and various data. A navigation application including map data is also, for example, installed on the ROM 26B or the storage 26D. Namely, a navigation system is installed in the vehicle 12. Furthermore, the ROM 26B or the storage 26D is also stored with vehicle related image data. The vehicle related image data is described later.

The communication I/F 26E is an interface for connecting the ECU 26 to other ECUs (omitted in the drawings) through an external bus (omitted in the drawings). This interface employs, for example, a communication standard under a CAN protocol.

The input/output I/F 26F is an interface for communication with various devices. These devices include, for example, the camera front center camera 21A, the front-left camera 21B, the front-right camera 21C, the left camera 21D, the right camera 21E, the millimeter wave radar, the LIDAR, the GPS receiver 22, the display device 23, the driving assistance operation device 25, and an actuator group (described later).

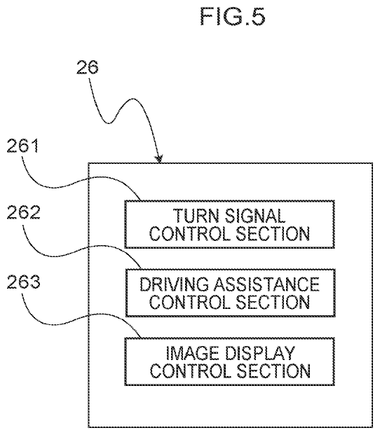

FIG. 5 illustrates a block diagram as an example of a functional configuration of the ECU 26. The ECU 26 incudes, as functional configuration, a turn signal control section 261, a driving assistance control section 262, and an image display control section 263. The turn signal control section 261, the driving assistance control section 262, and the image display control section 263 are implemented by the CPU 26A reading and executing the program stored on the ROM 26B.

The turn signal control section 261 controls left and right turn signals (omitted in the drawings) according to the position of the turn signal lever 20. Namely, when the turn signal lever 20 is at the left LCA operation position or at the left illumination position, a left turn signal that is a lamp provided at a front end portion of the vehicle 12 is illuminated under control of the turn signal control section 261. Moreover, when the turn signal lever 20 is in the right LCA operation position or the right illumination position, the right turn signal that is a lamp provided at a front end portion of the vehicle 12 is illuminated under control of the turn signal control section 261.

When the driving assistance operation device 25 is in an ON state, the driving assistance control section 262 utilizes the sensor group and the actuator group (omitted in the drawings) provided to the vehicle 12, and executes driving assistance control on the vehicle 12 of level 1 to level 5 automation in the driving automation scale (the automated driving scale) as defined by the Society of Automotive Engineers (SAE). Moreover, when the driving assistance operation device 25 is in the ON state, a level of driving automation and driving assistance control to be executed are selectable by an action of an occupant of the vehicle 12 on the driving assistance operation device 25. The driving assistance control of the present exemplary embodiment includes, for example, adaptive cruise control (ACC), lane keeping assist control/lane tracing assist (LTA), and lane change assist control/lane change assist (LCA). The sensor group provided to the vehicle 12 includes the sensor unit 21 (the front center camera 21A), the front-left camera 21B, the front-right camera 21C, the left camera 21D, and the right camera 21E. The actuator group provided to the vehicle 12 includes various electrical actuators for driving the brake system, electric power steering including the steering wheel 18, and an internal combustion engine serving as a driving source, and includes an electric motor serving as a driving source.

Simple explanation follows regarding LCA. Similarly to LTA, LCA is positional control in a lateral direction (lane width direction) with respect to the lane of the vehicle 12. LCA is started when driving assistance control of level 1 to 3 automation has been selected and the turn signal lever 20 has been moved to either the left LCA operation position or the right LCA operation position during execution of LTA and ACC. LCA is also started when the driving assistance control section 262 has determined a need to execute a lane change when driving assistance control of level 5 automation (fully autonomous driving) has been selected and a planned travel route has been set for the vehicle 12 using the navigation system. A specific LCA execution condition is established when LCA has been started.

After LCA has been started, the CPU 26A (the driving assistance control section 262) monitors the surroundings of the vehicle 12 based on information acquired from the sensor group. The CPU 26A furthermore moves the vehicle 12 either to the left side or the right side after determination has been made that the vehicle 12 can execute a lane change safely. For example, when LCA is executed by the turn signal lever 20 being moved to the left LCA operation position, the actuator group described above is controlled so as to move the vehicle 12 from a cruising lane that is the current lane of travel of the vehicle 12 to an adjacent lane that is a lane adjacent on the left side of the cruising lane. Moreover, when LCA is executed by the turn signal lever 20 being moved to the right LCA operation position, the actuator group described above is controlled so as to move the vehicle 12 from the cruising lane that is the current lane of travel of the vehicle 12 to an adjacent lane that is a lane adjacent on the right side of the cruising lane. The CPU 26A (the driving assistance control section 262) ends LCA when the vehicle 12 has been moved to a specific position in the adjacent lane on the left side or the right side.

Note that the driving assistance control section 262 interrupts LCA when a specific interrupt condition is established during LCA execution. For example, the interrupt condition is established when, during LCA execution, the driving assistance control section 262 has determined that a predicted time until the vehicle 12 will collide with an other-vehicle (TTC) has become less than a specific threshold. The above LCA execution condition is broken when the interrupt condition has been established or when LCA has finished.

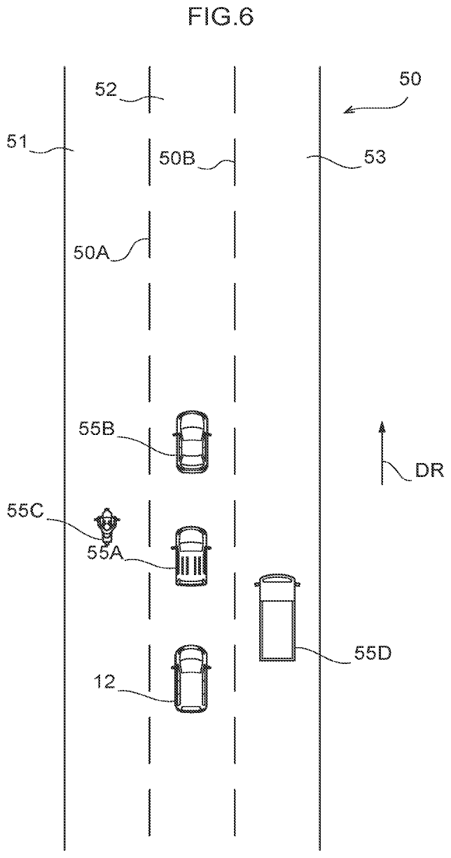

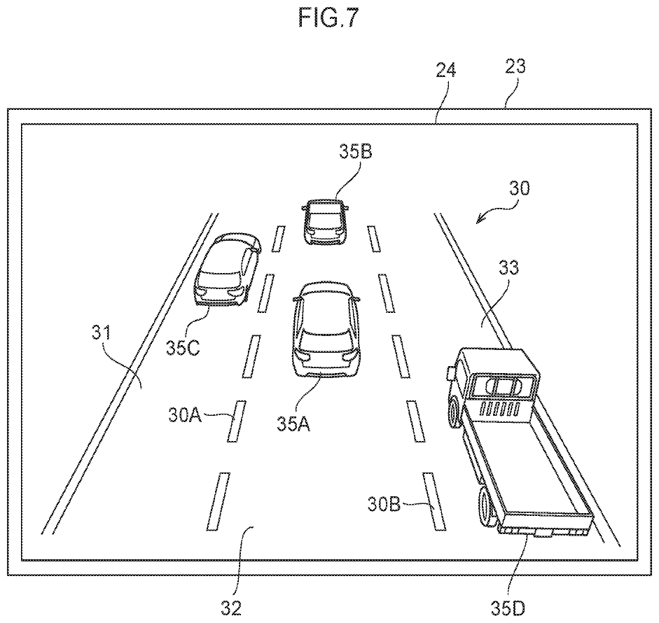

The image display control section 263 identifies the highway that the vehicle 12 is traveling on based on the car navigation system (map data) and location information. The image display control section 263 also reads the map data of the car navigation system and displays, on the display device 23, an image of the highway the vehicle 12 is currently traveling on. Consider, for example, a case in which the vehicle 12 is traveling on a highway 50 illustrated in FIG. 6. The highway 50 includes a first lane 51, a second lane 52, and a third lane 53. The first lane 51 and the second lane 52 are demarcated by a demarcation line 50A, and the second lane 52 and the third lane 53 are demarcated by a demarcation line 50B. An arrow DR illustrated in FIG. 6 indicates a progression direction of the vehicle 12. As illustrated in FIG. 7, for such a situation a highway image 30 displayed on the display device 23 includes a first lane image 31, a second lane image 32, and a third lane image 33. The first lane image 31 and the second lane image 32 are demarcated by a demarcation line image 30A, and the second lane image 32 and the third lane image 33 are demarcated by a demarcation line image 30B. Note an image displayed on the display device 23 as illustrated in FIG. 7 is an image when viewed looking obliquely forward from a virtual viewpoint (omitted in the drawings) directly above the vehicle 12.

Moreover, when the LCA execution condition is not established, the image display control section 263 utilizes camera images (image data) representing imaging subjects at positions in the surroundings of the vehicle 12 as acquired by the camera front center camera 21A, the front-left camera 21B, and the front-right camera 21C and utilizes a pattern matching method to determine whether or not there is a surrounding vehicle at a position in the surroundings of the vehicle 12 included in these camera images. Note that such a surrounding vehicle is not limited to being a four-wheeled vehicle, and may be a three-wheeled or two-wheeled vehicle. The image display control section 263 furthermore acquires image data representing the surrounding vehicle from the vehicle related image data when determined that there is a surrounding vehicle included in the camera images. The vehicle related image data of the present exemplary embodiment includes car image data representing a four-wheeled car, truck image data representing a four-wheeled truck, and a vehicle trajectory image. For example, consider a situation in which, for example as illustrated in FIG. 6, the vehicle 12 and cars 55A, 55B, which are two surrounding vehicles at positions in front of the vehicle 12, are traveling in the second lane 52, a two-wheeled vehicle 55C that is another surrounding vehicle is traveling in the first lane 51, and a truck 55D that is yet another surrounding vehicle is traveling in the third lane 53. In such a situation the image display control section 263 ascertains the relative positions of each of the surrounding vehicles with respect to the vehicle 12 based on detection results of the sensor group and camera images. Based on these relative positions, the image display control section 263 also, as illustrated in FIG. 7, displays car image data 35A, 35B, 35C and truck image data 35D representing each of the surrounding vehicles on the display device 23. The colors of the car image data 35A, 35B, 35C and the truck image data 35D are a particular color. For example, the car image data 35A, 35B, 35C and the truck image data 35D are white. This means that the car image data 35A, 35B, 35C and the truck image data 35D are, for example, displayed as white images on the display device 23. Thus when the LCA execution condition has not been established, images (the car image data 35A, 35B, 35C and the truck image data 35D) are displayed on the display device 23 in different colors and shapes to the actual colors and shapes of the surrounding vehicles.

However, when the LCA execution condition is established, the image display control section 263 uses camera images acquired by the front center camera 21A, the front-left camera 21B, the front-right camera 21C, the left camera 21D, and the right camera 21E to generate an image from a virtual viewpoint.

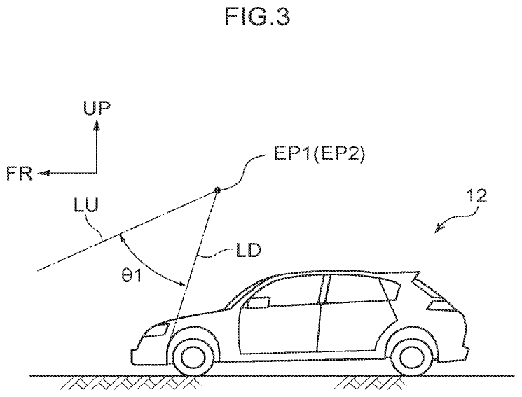

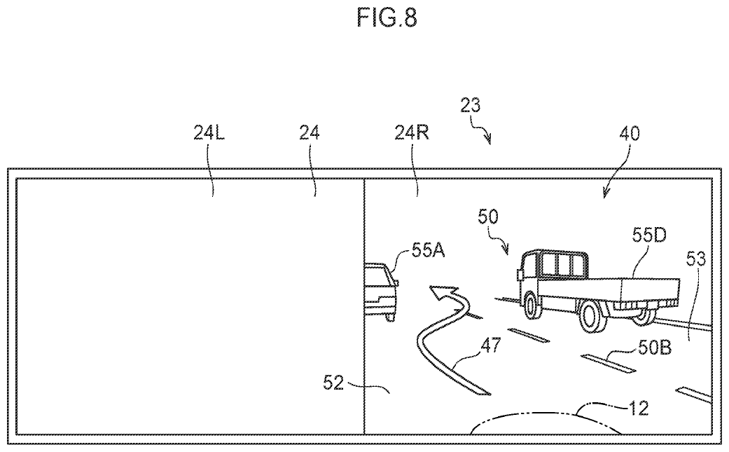

Explanation first follows regarding a virtual viewpoint image 40 generated when the vehicle 12 is being moved to an adjacent lane on the right by LCA. In such a situation, the image display control section 263 generates image data that will be the basis for the virtual viewpoint image 40 illustrated in FIG. 8 by merging the camera images acquired by the front center camera 21A, the front-right camera 21C, and the right camera 21E and performing viewpoint conversion processing thereon. A virtual viewpoint EP1 in such cases is the position illustrated in FIG. 2 and FIG. 3. The virtual viewpoint EP1 is a position at a left side of a center line (center) CL passing in a front-rear direction through a vehicle width direction center of the vehicle 12 in plan view as illustrated in FIG. 2, and is a position above an upper end of the vehicle 12 in side view as illustrated in FIG. 3. A range of the virtual viewpoint image 40 in plan view is an imaging area between two straight lines L1L, L1R extending from the virtual viewpoint EP1 as illustrated in FIG. 2. Note that an angle (angle of view) formed between the straight line L1L and the straight line L1R in plan view is 01. The range of the virtual viewpoint image 40 in side view is an imaging area between two straight lines LU, LD extending from the virtual viewpoint EP1 as illustrated in FIG. 3. An angle (angle of view) formed between the straight line LU and the straight line LD in side view is θ1. Most of this imaging area is positioned in front of and to the right side of the front windshield 15 and the head of an occupant in plan view.

Furthermore, the image display control section 263 displays the virtual viewpoint image 40 based on this image data on the display area 24 of the display device 23, as illustrated in FIG. 8. When doing so the image display control section 263 divides the display area 24 into a first area 24R that is a right half thereof and a second area 24L that is a left half thereof. Moreover, the image display control section 263 displays the virtual viewpoint image 40 on the first area 24R. As illustrated in FIG. 8, part (a front portion) of the vehicle 12 is included in the virtual viewpoint image 40. Furthermore, the image display control section 263 reads a vehicle trajectory image 47 (vehicle related image data) representing a vehicle trajectory for the vehicle 12 to execute a lane change, and displays the vehicle trajectory image 47 on the display device 23.

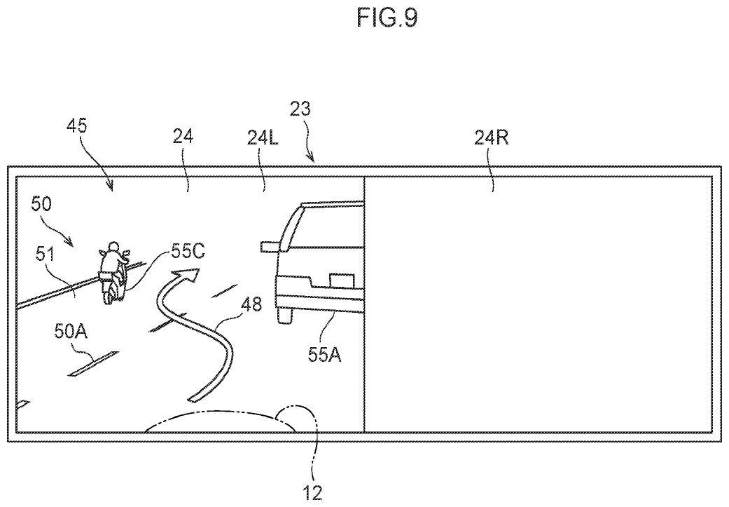

Description next follows regarding a virtual viewpoint image 45 generated in cases in which the vehicle 12 is being moved to an adjacent lane on the left by LCA. The image display control section 263 generates image data that will be the basis for the virtual viewpoint image 45 illustrated in FIG. 9 by merging the camera images acquired by the front center camera 21A, the front-left camera 21B, and the left camera 21D and performing viewpoint conversion processing thereon. A virtual viewpoint EP2 in such cases is the position illustrated in FIG. 2 and FIG. 3. The virtual viewpoint EP2 is a position at a right side of the center line CL in plan view as illustrated in FIG. 2, and is a position above an upper end of the vehicle 12 in side view as illustrated in FIG. 3. A range of the virtual viewpoint image 45 in plan view is an imaging area between two straight lines L2L, L2R extending from the virtual viewpoint EP2 illustrated in FIG. 2. Note that an angle (angle of view) formed between the straight line L2L and the straight line L2R in plan view is θ1. The range of the virtual viewpoint image 45 in side view is an imaging area between the two straight lines LU, LD extending from the virtual viewpoint EP2 as illustrated in FIG. 3. Most of this imaging area is positioned in front of and to the left side of the front windshield 15 and the head of an occupant in plan view.

Note that the positions of the virtual viewpoints EP1 and EP2 may be set further rearward than the positions illustrated in FIG. 2 and FIG. 3. For example, in side view the virtual viewpoints EP1, EP2 may be positioned rearward of the front seats 13L, 13R, and may be positioned rearward of the position of the rearmost seats provided to the vehicle 12. Note that in such cases the left camera 21D and the right camera 21E may be provided to the vehicle 12 so as to be positioned rearward of the positions illustrated in FIG. 2.

Furthermore, the image display control section 263, as illustrated in FIG. 9, displays the virtual viewpoint image 45 that is the image based on this image data in the second area 24L of the display area 24 of the display device 23. As illustrated in FIG. 9, part (a front portion) of the vehicle 12 is included in the virtual viewpoint image 45. The image display control section 263 furthermore reads a vehicle trajectory image 48 (vehicle related image data) representing a vehicle trajectory for the vehicle 12 to execute a lane change, and displays the vehicle trajectory image 48 on the display device 23.

The GPS receiver 22, the display device 23, the driving assistance operation device 25, the ECU 26, the sensor group, and the actuator group are configuration elements of the vehicle control device 10.

### Operation and Advantageous Effects

Next, description follows regarding the operation and advantageous effects of the present exemplary embodiment

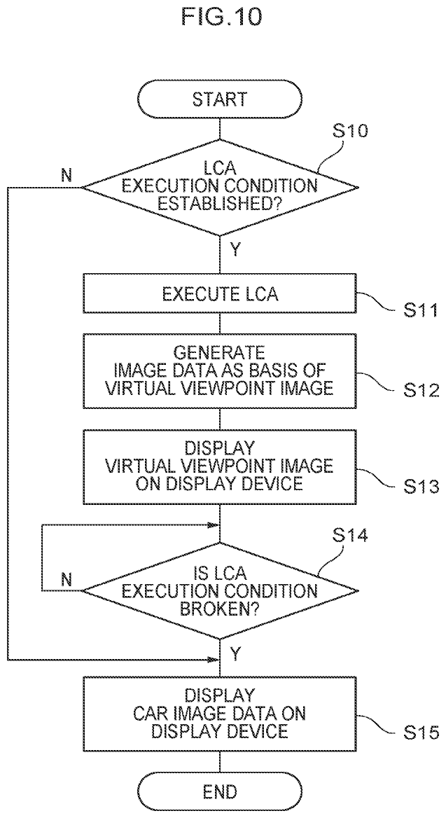

Next, description follows regarding processing executed by the CPU 26A of the ECU 26. The CPU 26A repeatedly executes the processing of the flowchart illustrated in FIG. 10 each time the specific period of time elapses.

At step S10 (“step” will be omitted hereafter), the CPU 26A determines whether or not the LCA execution condition is established.

The CPU 26A proceeds to S11 in cases in which determination was YES at S10 and executes LCA.

The CPU 26A next proceeds to S12, and generates image data that will be the basis of the virtual viewpoint image 40 or 45 according to the position of the turn signal lever 20.

The CPU 26A proceeds to S13 when the processing of S12 has finished, and displays the virtual viewpoint image 40 or the virtual viewpoint image 45 on the display device 23.

The CPU 26A proceeds to S14 when the processing of S13 is finished and determines whether or not the LCA execution condition is broken.

The CPU 26A proceeds to S15 when YES was determined at S14 or when NO was determined at S10, and displays car image data on the display device 23 instead of the virtual viewpoint image 40 or 45.

The CPU 26A temporarily ends the processing of the flowchart of FIG. 10 when the processing of S15 has finished.

In the present exemplary embodiment as described above, the virtual viewpoint image 40 or 45 is displayed on the display device 23 when the vehicle 12 is executing LCA to perform a lane change to one side out of toward the left or toward the right. The virtual viewpoint images 40, 45 are generated by merging the image data acquired by plural cameras from out of the front center camera 21A, the front-left camera 21B, the front-right camera 21C, the left camera 21D, and the right camera 21E, and performing viewpoint conversion processing thereon. Furthermore, for example, the virtual viewpoint EP1 is positioned at a left side (other side out of toward the left or toward the right) of the center line CL in plan view when the vehicle 12 is performing a lane change toward the right, and the virtual viewpoint EP2 is positioned at a right side of the center line CL in plan view when the vehicle 12 is performing a lane change toward the left. This means that, for example, the virtual viewpoint image 40 is an image representing an area in front of and to the right side as viewed from the occupant when the vehicle 12 is performing a lane change to the right side. In other words, the virtual viewpoint image 40 is an image enabling the occupant to readily ascertain a vehicle trajectory (the vehicle trajectory image 47) for when the vehicle 12 performs a lane change. The occupant who has looked at the display device 23 during execution of LCA is accordingly able to correctly ascertain the situation in an area positioned in the movement direction of the vehicle 12.

Furthermore, the virtual viewpoint image 40 is displayed in the first area 24R further to the right than the left-right direction center of the display area 24 when the vehicle 12 is performing a lane change to the right. Moreover, the virtual viewpoint image 45 is displayed in the second area 24L further to the left that the left-right direction center of the display area 24 when the vehicle 12 is performing a lane change to the left. This means that the occupant who has looked at the display device 23 during LCA execution is readily able to directly ascertain that the virtual viewpoint image 40 or 45 displayed on the display area 24 represents an area in the progression direction of the vehicle 12 (lane change direction).

Furthermore, the image representing part of the vehicle 12 is displayed in the first area 24R or the second area 24L during LCA execution. The occupant who has looked at the display device 23 is accordingly able to ascertain the positional relationships between the vehicle 12 and the surrounding vehicles. This thereby reduces a concern that the occupant who has looked at the display device 23 during LCA execution might feel unsettled compared to cases in which the vehicle 12 is not displayed on the display device 23.

Although the vehicle control device 10, the vehicle control method, and the non-transitory storage medium according to the exemplary embodiment have been described above, appropriate design changes may be made thereto within a range not departing from the spirit of the present disclosure.

For example, the cameras mounted to the vehicle 12 are not limited to those described. For example, a configuration in which the front-left camera 21B and the front-right camera 21C are not provided to the vehicle 12 may be adopted in cases in which the angle of view of the front center camera 21A is large. In such cases, for example, the virtual viewpoint image is formed using camera images acquired by the front center camera 21A and the right camera 21E when the vehicle 12 is performing a lane change to the right. Moreover, the virtual viewpoint image is formed using camera images acquired by the front center camera 21A and the left camera 21D when the vehicle 12 is performing a lane change to the left.

What is claimed is:

1. A vehicle control device comprising a processor, wherein:
when a vehicle is executing driving assistance control to change lanes toward one side of either the left or the right, the processor:
generates a virtual viewpoint image representing an area positioned further in front of and further toward the one side than an occupant of the vehicle based on image data acquired by cameras mounted to the vehicle and based on a virtual viewpoint positioned further to another side of either the left or the right than a vehicle width direction center of the vehicle; and
causes display of the virtual viewpoint image on a display device provided at the vehicle.

2. The vehicle control device of claim 1, wherein:
the display device is positioned further in front than a seat of the vehicle;
the display device includes a display area capable of displaying the virtual viewpoint image; and
the processor causes display of the virtual viewpoint image in an area on the one side of a left-right direction center of the display area.

3. The vehicle control device of claim 1, wherein the processor causes display of an image representing the vehicle on the display device.

4. A vehicle control method comprising, when a vehicle is executing driving assistance control to change lanes toward one side of either the left or the right, by a processor:
generating a virtual viewpoint image representing an area positioned further in front of and further toward the one side than an occupant of the vehicle based on image data acquired by cameras mounted to the vehicle and based on a virtual viewpoint positioned further to another side of either the left or the right of a vehicle width direction center of the vehicle; and
causing display of the virtual viewpoint image on a display device provided at the vehicle.

5. A non-transitory storage medium storing a program executable by a computer so as to perform processing, the processing comprising:
when a vehicle is executing driving assistance control to change lanes toward one side of either the left or the right:
generating a virtual viewpoint image representing an area positioned further in front of and further toward the one side than an occupant of the vehicle based on image data acquired by cameras mounted to the vehicle and based on a virtual viewpoint positioned further to another side of either the left or the right than a vehicle width direction center of the vehicle, and
displaying the virtual viewpoint image on a display device provided at the vehicle.
